(19) United States
(12) Patent Application Publication
(10) Pub. No.: US 2006/0285037 A1
(43) Pub. Date: Dec. 21, 2006

(54) Apparatus for mixing light beams and backlight module having the same

(75) Inventors: Shen-Yin Tsai, Tainan City (TW); Chen-Ze Hu, Jhonghe City (TW); Chin-Lung Kuo, Tainan City (TW); I-Chang Lee, Tainan City (TW)

Correspondence Address: LADAS & PARRY, 26 WEST 61ST STREET, NEW YORK, NY, 10023, US

(73) Assignee: CHI LIN TECHNOLOGY CO., LTD.

(21) Appl. No.: 11/158,031

(22) Filed: Jun. 21, 2005

(51) Int. Cl. G02F 1/1335

(52) U.S. Cl. 349/115

(57) ABSTRACT

The present invention relates to an apparatus for mixing light beams, which has at least one cholesteric liquid crystal (CLC) layer disposed between a reflective plate and an upper plate so as to form two mixing areas. Because the cholesteric liquid crystal (CLC) layer has a property of reflecting narrow band-circular polarized light, the light beams emitted from a plurality of light source are mixed in the two mixing areas. As a result, the height of the mixing area is reduced, and the color-mixing performance is raised.

### BACKGROUND OF THE INVENTION

1. Field of the Invention

The present invention relates to an apparatus for mixing light beams and a backlight module having the same, particularly to an apparatus having two mixing areas by utilizing at least one cholesteric liquid crystal (CLC) layer.

2. Description of the Related Art

FIG. 1 shows a schematic view of a conventional direct-type backlight module. The direct-type backlight module 1 is used in a liquid crystal display and comprises a diffusion plate 10, a plurality of light emitting diodes (LEDs) 11, 12, 13 and a reflector 14.

The diffusion plate 10 is a transparent substrate doped with diffusion particles therein or thereon. The diffusion plate 10 has a top surface 101 and a bottom surface 102, wherein the bottom surface 102 is an illuminated surface for receiving the incident light beams from the light emitting diodes (LEDs) 11, 12, 13 and reflected by the reflector 14. The light emitting diodes (LEDs) 11, 12, 13 are the light source of the direct-type backlight module 1 and are disposed on the reflector 14. The light emitting diodes (LEDs) 11, 12, 13 comprise a red LED 11, a green LED 12 and a blue LED 13, wherein the red LED 11 emits a red light beam 15, the green LED 12 emits a green light beam 16 and the blue LED 13 emits a blue light beam 17. The reflector 14 is used for reflecting the light beams 15, 16, 17.

In the direct-type backlight module 1, since the light sources are LEDs of different colors, it is necessary to mix the light beams 15, 16, 17 into a white light beam. According to a conventional way for mixing light beams, as shown in FIG. 1, a space 18 formed between the diffusion plate 10 and the reflector 14 is a mixing area. The light beams 15, 16, 17 are mixed in the space 18 naturally to become a white light beam. Unfortunately, such conventional way needs large space 18, which is not suitable for the liquid crystal display that is becoming smaller in size and lighter in weight. Additionally, the light beams 15, 16, 17 are not uniformly mixed. In order to overcome the above-mentioned shortcoming, U.S. Pat. Nos. 6,139,166 and 6,604,839 B2 and US. Pub. No. 2004/0061810 disclose various apparatuses for mixing light beams. However, such apparatuses are complex, bulky and expensive.

Consequently, there is an existing need for a novel and improved apparatus for mixing light beams to solve the above-mentioned problem.

### SUMMARY OF THE INVENTION

One objective of the present invention is to provide an apparatus for mixing light beams, which has two mixing areas by utilizing at least one cholesteric liquid crystal (CLC) layer. As a result, the height of the mixing area is reduced, and the color-mixing performance is raised.

Another objective of the present invention is to provide an apparatus for mixing light beams, which has at least one cholesteric liquid crystal (CLC) layer. Because the cholesteric liquid crystal has a property of reflecting narrow band-circular polarized light, the apparatus can be used in a backlight module that has light source of LEDs so as to raise the color-mixing performance of the LEDs.

Still another objective of the present invention is to provide an apparatus for mixing light beams, comprising: a reflective plate, a receiving plate, a first light source, a second light source, a first cholesteric liquid crystal (CLC) layer, a second cholesteric liquid crystal (CLC) layer and an upper plate. The reflective plate is used for reflecting light beams. The receiving plate is disposed above the reflective plate and apart from the reflective plate by a first space. The first light source is used for emitting a first light beam. The second light source is used for emitting a second light beam. The first cholesteric liquid crystal (CLC) layer is disposed on the receiving plate, and the polarized reflection and property of transmittance of the first cholesteric liquid crystal (CLC) layer correspond to the first light beam. The second cholesteric liquid crystal (CLC) layer is disposed on the receiving plate, and the polarized reflection and property of transmittance of the second cholesteric liquid crystal (CLC) layer correspond to the second light beam. The upper plate is disposed above the receiving plate and apart from the receiving plate by a second space, whereby the first light beam and the second light beam are mixed in the first space and the second space.

### BRIEF DESCRIPTION OF THE DRAWINGS

FIG. 1 shows a schematic view of a conventional direct-type backlight module; and

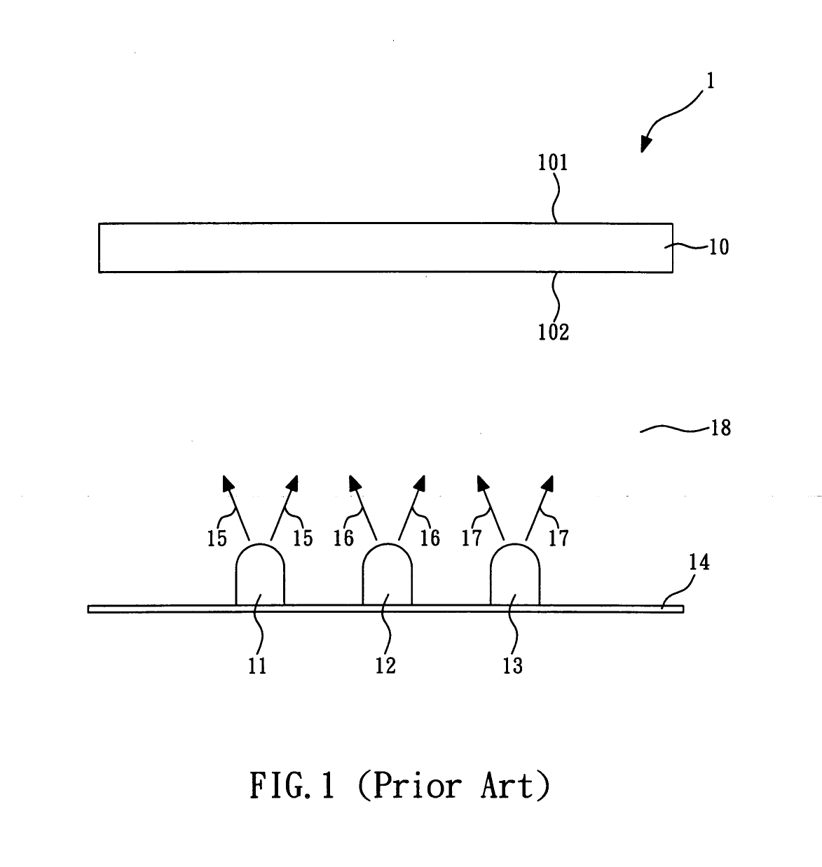

FIG. 2 shows a schematic view of an apparatus for mixing light beams according to the present invention.

### DETAILED DESCRIPTION OF THE INVENTION

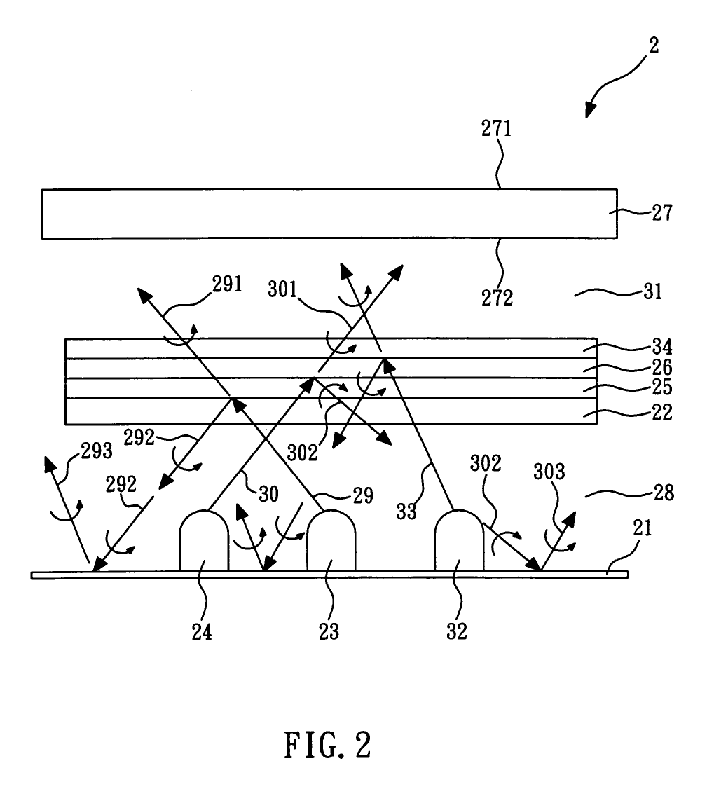

FIG. 2 shows a schematic view of an apparatus for mixing light beams according to the present invention. The apparatus 2 is used in a backlight module of a liquid crystal display. The apparatus 2 comprises a reflective plate 21, a receiving plate 22, a first light source 23, a second light source 24, a first cholesteric liquid crystal (CLC) layer 25, a second cholesteric liquid crystal (CLC) layer 26 and an upper plate 27.

The reflective plate 21 is used for reflecting light beams and changing the polarization direction of the light beams. The receiving plate 22, for example, a lens or other transparent mechanisms, is disposed above the reflective plate 21. It should be noted that the interior or surface of the receiving plate 22 might be doped with diffusion particles. The space between the receiving plate 22 and the reflective plate 21 is defined as a first mixing area 28.

The first light source 23 is used for emitting a first light beam 29 having a first wavelength. The second light source 24 is used for emitting a second light beam 30 having a second wavelength. In the embodiment, the first light source 23 is a red LED, the first light beam 29 is red light beam, the second light source 24 is a green LED, and the second light beam 30 is green light beam. It is understood that the apparatus may further comprise light source of other color, for example, a third light source 32 that is a blue LED for emitting blue third light beam 33.

In the embodiment, the first light source 23, the second light source 24 and the third light source 32 are disposed in the first mixing area 28, which forms a direct-type backlight module. Alternatively, if the first light source 23, the second light source 24 and the third light source 32 are disposed outside the first mixing area 28, they form a side-edge backlight module.

The first cholesteric liquid crystal (CLC) layer 25 is disposed on the receiving plate 22 by adhering or coating. The polarized reflection and property of transmittance of the first cholesteric liquid crystal (CLC) layer 25 correspond to the first wavelength of the first light beam 29. That is, the first cholesteric liquid crystal (CLC) layer 25 is used for partially reflecting the first light beam 29. The second cholesteric liquid crystal (CLC) layer 26 is disposed on the first cholesteric liquid crystal (CLC) layer 25. The polarized reflection and property of transmittance of the second cholesteric liquid crystal (CLC) layer 26 correspond to the second wavelength of the second light beam 30. That is, the second cholesteric liquid crystal (CLC) layer 26 is used for partially reflecting the second light beam 30. Additionally, if there is the third light source 32, it is necessary to add a third cholesteric liquid crystal (CLC) layer 34 disposed on the second cholesteric liquid crystal (CLC) layer 26. The polarized reflection and property of transmittance of the third cholesteric liquid crystal (CLC) layer 34 correspond to the third wavelength of the third light beam 33. That is, the third cholesteric liquid crystal (CLC) layer 34 is used for partially reflecting the third light beam 33.

The upper plate 27 is disposed above the receiving plate 22 and the space between the upper plate 27 and the receiving plate 22 is defined as a second mixing area 31. The upper plate 27 is a transparent substrate, or its interior or surface may be doped with diffusion particles. The upper plate 27 has a top surface 271 and a bottom surface 272, wherein the bottom surface 272 is an illuminated surface for receiving the incident light beams from the light sources 23, 24, 32 and reflected by the reflector 21. It should be noted that if the apparatus 2 is applied to a backlight module, the upper plate 27 is a diffusion plate.

The operation of the apparatus 2 is as follows. When the first light beam 29 passes through the receiving plate 22 and enters the first cholesteric liquid crystal (CLC) layer 25, it is split into two orthogonal circularly polarized lights, one of which is left-handed circularly polarized light (light 291) and the other is right-handed circularly polarized light (light 292), then in the embodiment, the light 291 (left-handed circularly polarized light) passes through the first cholesteric liquid crystal (CLC) layer 25, the second cholesteric liquid crystal (CLC) layer 26 and the third cholesteric liquid crystal (CLC) layer 34, and then enters the second mixing area 31.

The light 292 (right-handed circularly polarized light) is reflected to the first mixing area 28, and is then reflected by the reflective plate 21 to become a left-handed circularly polarized light (light 293). The light 293 is like the light 291 that can pass through the first cholesteric liquid crystal (CLC) layer 25, the second cholesteric liquid crystal (CLC) layer 26 and the third cholesteric liquid crystal (CLC) layer 34, and then enters the second mixing area 31.

In the same way, when the second light beam 30 passes through the receiving plate 22 and the first cholesteric liquid crystal (CLC) layer 25, and enters the second cholesteric liquid crystal (CLC) layer 26, it is split into two orthogonal circularly polarized lights, one of which is left-handed circularly polarized light (light 301) and the other is right-handed circularly polarized light (light 302), then in the embodiment, the light 301 (left-handed circularly polarized light) passes through the first cholesteric liquid crystal (CLC) layer 25, the second cholesteric liquid crystal (CLC) layer 26 and the third cholesteric liquid crystal (CLC) layer 34, and then enters the second mixing area 31 so as to mix with the light 291.

The light 302 (right-handed circularly polarized light) is reflected to the first mixing area 28 so as to mix with the light 292, and then the light 302 is reflected by the reflective plate 21 to become a left-handed circularly polarized light (light 303). The light 303 is like the light 301 that can pass through the first cholesteric liquid crystal (CLC) layer 25, the second cholesteric liquid crystal (CLC) layer 26 and the third cholesteric liquid crystal (CLC) layer 34, and then enters the second mixing area 31.

According to the present invention, there are two mixing areas 28, 31 for light beams to proceed mixing so that the height of mixing area is reduced hugely, and the total height of the apparatus 2 is also reduced. Additionally, since high color-mixing performance can be achieved by utilizing several cholesteric liquid crystal (CLC) layers, the manufacture cost is low.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An apparatus for mixing light beams, comprising:
a first light source for emitting a first light beam;
a second light source for emitting a second light beam;
a reflective plate for reflecting light beams;
a receiving plate disposed above the reflective plate and apart from the reflective plate by a first space;
a first cholesteric liquid crystal (CLC) layer disposed on the receiving plate, wherein the polarized reflection and property of transmittance of the first cholesteric liquid crystal (CLC) layer correspond to the first light beam;
a second cholesteric liquid crystal (CLC) layer disposed on the receiving plate, wherein the polarized reflection and property of transmittance of the second cholesteric liquid crystal (CLC) layer correspond to the second light beam; and
an upper plate disposed above the receiving plate and apart from the receiving plate by a second space.

2. The apparatus according to claim 1, further comprising:
a third light source for emitting a third light beam; and
a third cholesteric liquid crystal (CLC) layer disposed on the receiving plate, wherein the polarized reflection and property of transmittance of the third cholesteric liquid crystal (CLC) layer correspond to the third light beam.

3. The apparatus according to claim 1, wherein the first light source and the second light source are light emitting diodes (LEDs) of different colors.

4. The apparatus according to claim 2, wherein the first light source, the second light source and the third light source are light emitting diodes (LEDs) of different colors.

5. The apparatus according to claim 2, wherein the third light source is disposed in the first space.

6. The apparatus according to claim 1, wherein the first light source and the second light source are disposed in the first space.

7. A backlight module comprising the apparatus of claim 1, wherein the upper plate is a diffusion plate.

8. A display device comprising the backlight module of claim 7.

9. An apparatus for mixing light beams, comprising:
a reflective plate for reflecting light beams and changing the direction of the light beams;
a receiving plate disposed above the reflective plate and apart from the reflective plate by a first mixing area;
a first light source for emitting a first light beam having a first wavelength, wherein the first light beam can be split into a first polarized light and a second polarized light;
a second light source for emitting a second light beam having a second wavelength, wherein the second light beam can be split into a third polarized light and a fourth polarized light;
a first cholesteric liquid crystal (CLC) layer disposed on the receiving plate, wherein the polarized reflection and property of transmittance of the first cholesteric liquid crystal (CLC) layer correspond to the first light beam so as to transmit the first polarized light and reflect the second polarized light to the first mixing area;
a second cholesteric liquid crystal (CLC) layer disposed on the receiving plate, wherein the polarized reflection and property of transmittance of the second cholesteric liquid crystal (CLC) layer correspond to second light beam so as to transmit the third polarized light and reflect the fourth polarized light to the first mixing area; and
an upper plate disposed above the receiving plate and apart from the receiving plate by a second mixing area, wherein the first and third polarized lights that pass through the first and second cholesteric liquid crystal (CLC) layers respectively are mixed in the second mixing area;
whereby the second and fourth polarized lights that are reflected by the first and second cholesteric liquid crystal (CLC) layers, respectively are mixed in the first mixing area and then reflected by the reflective plate and then enter the second mixing area.

10. The apparatus according to claim 9, further comprising:
a third light source for emitting a third light beam having a third wavelength; and
a third cholesteric liquid crystal (CLC) layer disposed on the receiving plate, wherein the polarized reflection and property of transmittance of the third cholesteric liquid crystal (CLC) layer correspond to the third light beam.

11. The apparatus according to claim 9, wherein the first light source and the second light source are light emitting diodes (LEDs) of different colors.

12. The apparatus according to claim 10, wherein the first light source, the second light source and the third light source are light emitting diodes (LEDs) of different colors.

13. The apparatus according to claim 10, wherein the third light source is disposed in the first mixing area.

14. The apparatus according to claim 9, wherein the first light source and the second light source are disposed in the first mixing area.

15. A backlight module comprising the apparatus of claim 9, wherein the upper plate is a diffusion plate.

16. A display device comprising the backlight module of claim 15.
